(19) United States
(12) Patent Application Publication
(10) Pub. No.: US 2019/0156690 A1
(43) Pub. Date: May 23, 2019

(54) VIRTUAL REALITY SYSTEM FOR SURGICAL TRAINING

(71) Applicant: Medical Realities Limited, London (GB)

(72) Inventors: Ciarán Carrick, London (GB); James Pendry, London (GB); Matthew Leatherbarrow, London (GB); Joseph Marritt, London (GB); Stephen Dann, London (GB); Shafi Ahmed, London (GB)

(21) Appl. No.: 15/817,784

(22) Filed: Nov. 20, 2017

(51) Int. Cl. G09B 5/06; G06F 3/0482; G09B 9/00; G06F 3/0484; G06F 3/0485; G06F 3/0481

(52) U.S. Cl. CPC G09B 5/065; G06F 3/0482; G06F 3/04815; G06F 3/04845; G06F 3/0485; G09B 9/00

(57) ABSTRACT

A computer-implemented method for providing a graphical user interface for use in a virtual reality system. A virtual reality simulation of a user's view of a simulated virtual reality environment is generated and output for display on a virtual reality display, the virtual reality environment comprising the graphical user interface. The graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user. In response to receiving an indication of a selection of one of the one or more selectable cells, one or more further cells are positioned within the simulated virtual reality environment adjacent to the selected cell such that the graphical user interface is built around the user within the virtual reality environment.

### TECHNICAL FIELD

The present disclosure relates to virtual reality methods and systems. In particular, but without limitation, this disclosure relates to methods and systems for providing a graphical user interface for use in a virtual reality system.

### BACKGROUND

Surgical training can oftentimes be expensive due to the requirement for surgical trainees to be present in operating theatres to view surgical procedures. Furthermore, the training opportunities for surgical trainees can be limited by the specific surgical procedures that are performed in their training hospitals. This can make it difficult to train surgeons to perform relatively rare operations.

There is therefore a need for an improved means of providing training to surgical trainees.

Virtual reality systems offer the opportunity to allow surgical trainees to be trained more efficiently on a wider variety of surgical procedures. Nevertheless, there are a number of problems associated with trying to provide effective training within virtual reality systems.

Users can often become disoriented when attempting to navigate through large menu structures within virtual reality graphical user interfaces. Furthermore, it can be difficult to effectively present a large amount of text within a virtual reality environment. In addition, there can be issues regarding the rendering and synchronisation of a number of different types of content within a virtual reality system due to the technical challenges of providing a full 3D virtual reality environment.

Accordingly, there is a need for a virtual reality system that provides an improved graphical user interface and that can effectively present a number of different types of content within a virtual reality environment.

### BRIEF DESCRIPTION OF THE DRAWINGS

Arrangements of the present invention will be understood and appreciated more fully from the following detailed description, made by way of example only and taken in conjunction with drawings in which:

FIG. 1 shows how server-side entities interact a client application according to an arrangement;

FIG. 2 shows an example of a content management system according to an arrangement;

FIG. 3 shows a token purchase method for a virtual reality system;

FIG. 4 shows an example of a virtual reality system according to an arrangement;

FIG. 5 shows an example of a graphical user interface for a virtual reality system;

FIG. 6 shows a first view of an improved user interface according to an arrangement;

FIG. 7 shows a second view of the user interface of FIG. 6;

FIG. 8 shows a third view of the user interface of FIG. 6;

FIG. 9 shows how cells react to a user's changing direction of view according to an arrangement;

FIG. 10 shows a scrolling functionality of the present arrangement; and

FIG. 11 shows an example of a user interface for adding hotspots to a virtual reality video.

### SUMMARY OF INVENTION

According to a first aspect of the invention there is provided a computer-implemented method for providing a graphical user interface for use in a virtual reality system. The method comprises a computing system receiving an input indicating a current direction of view of a user and generating and outputting a virtual reality simulation of the user's view of a simulated virtual reality environment for display on a virtual reality display. The virtual reality environment comprises the graphical user interface. The graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user. In response to receiving an indication of a selection of one of the one or more selectable cells, one or more further cells are positioned within the simulated virtual reality environment adjacent to the selected cell such that the graphical user interface is built around the user within the virtual reality environment.

Accordingly, a user interface for a virtual reality system is described herein in which the user interface is built up around the position of the user within the virtual reality environment. This allows large menu structures with multiple levels to be implemented, with the user maintaining an awareness of their position within the menu structure based on their natural spatial awareness. This also allows the user to efficiently view and make selections from different levels of the user interface without having to navigate away from or close the lowest level.

The methods described herein may be applied to full virtual reality, where the entirety of the user's field of view is occupied by the virtual environment, or augmented reality, wherein the user views a combination of the virtual environment and the real environment surrounding the user.

In one arrangement the one or more fixed positions are fixed relative to the local coordinate system of the virtual reality environment. The local coordinate system may be fixed relative to a given direction within the virtual reality environment (e.g. “north”), and centred on the position of the user.

The user interface is therefore static within the virtual reality environment, allowing the user to turn to view various aspects of the user interface. Accordingly, in response to the user looking towards the one or more further cells, an updated virtual reality view may be output to display the one or more further cells within the simulated virtual reality environment.

Whilst the one or more selectable cells and the one or more further cells are adjacent to each other, they need to be touching. Instead, they could be next to each other but spaced apart from each other.

The input indicating the current direction of view might be determined by a head tracking system. The head tracking system may be integral to the computing system, or external to the computing system but in communicative connection with the computing system. The head tracking system may track the position and orientation of the user's head in order to determine the direction of view.

In one arrangement, generating and outputting a virtual reality simulation comprises:
A. receiving an updated input describing a direction of view of the user;
B. generating and outputting a virtual reality view simulating the user's view along the updated direction of view of the virtual reality environment comprising the graphical user interface; and
C. repeating A and B in real time as the user's direction of view changes over time.

The method may therefore continually update the virtual reality view in real time as the user changes their direction of view.

According to a further arrangement the one or more selectable cells are positioned within the virtual reality environment at a first yaw angle about the user relative to a fixed coordinate system and the one or more further cells are positioned at a second yaw angle about the user relative to the fixed coordinate system, wherein the second yaw angle is different to the first yaw angle.

A yaw angle can be considered to be the angle around a vertical axis that is centred on the position of the user within the virtual reality environment. The one or more further cells may be positioned at the same distance from the user as the one or more selectable cells. Accordingly, user interface may be built up in an arc or circle around the user. The one or more further cells may be positioned to the left or right of the one or more selectable cells from the point of view of the user.

According to a further arrangement the one or more selectable cells comprise a plurality of selectable cells arranged vertically in a column at the first yaw angle and the one or more further cells comprise a plurality of further cells arranged vertically in a column at the second yaw angle. This allows a list of menu of cells to be presented to the user in columns. The different columns may represent different groups of related content. The different columns may represent different levels within a hierarchical menu structure. The one or more selectable cells may be a top level, or a lower level within the hierarchical menu structure. The one or more further cells are lower in the menu structure to the one or more selectable cells.

Each of the cells within the user interface could be positioned along a sphere centred on the user. Accordingly, each vertical column may be curved around user from top to bottom. Each cell may be located an equivalent distance away from the user within the virtual reality environment.

According to a further arrangement one or both of the columns of selectable cells and the column of further cells is shaded or coloured with a gradient that changes along a vertical axis to provide feedback to the user regarding their view within the graphical user interface. The gradient may be smooth (e.g. a “sunrise” effect), with the colouring or shading changing across each cell) or quantised, in that each cell may have a single shading and/or colouring but the shading and/or colouring differs between cells within a column. The gradient could increase or decrease down the column.

According to a further arrangement the column of selectable cells has one or more of a shading or colouring that is different to the column of further cells to provide feedback to the user regarding their view within the graphical user interface. Accordingly, different levels within the user interface may be shaded or coloured differently.

According to a further arrangement the one or more further cells form part of a set of further cells, the one or more further cells are displayed within a predefined region within the virtual reality environment, and, in response to the direction of view being directed towards the top of the region, the further cells within the column are scrolled downwards within the predefined region to present additional cells from the set of further cells, or, in response to the direction of view being directed towards the bottom of the region, the further cells within the column are scrolled upwards within the predefined region to present additional cells from the set of further cells. This provides a simple and effective way of presenting a large list of cells to the user in a restricted region. Scrolling can be considered moving content (e.g. cells) within the virtual reality environment itself, rather than simply moving content within the view of the user as the user's viewpoint changes.

The position of the set of further cells within the predefined region may be defined based on the intercept point between the direction of view and the predefined region. The scrolling may be scaled across the height of the predefined region. The set of further cells may be scrolled by an amount proportional to the position of the intercept point relative to the overall height of the predefined region. For instance, the distance of the intercept point from the top of the predefined region may be determined, the percentage of the distance relative to the total height of the predefined region may be calculated, and then this percentage may be used to determine a proportional amount of scrolling by defining a distance equal to the same percentage relative to the total height of the set of further cells.

A minimum threshold may be set to the scrolling wherein scrolling only occurs when the direction of view is changed by more than the minimum threshold. The scrolling may be divided into steps. The height of the predefined region may be divided into a set of equally sized strips from the top of the predefined region to the bottom of the predefined region. Each strip may relate to a range of distances from the top of the predefined region. The height of each strip may be equal to the total height of the predefined region divided by the number of steps. Each region may be associated with a corresponding amount that the set of further cells is to be scrolled relative to the previous region. This amount may be equal to the total height of the set of further cells divided by the number of steps.

According to a further arrangement the one or more further cells are positioned so that they do not overlap with the one or more selectable cells. This ensures that the cells are fully viewable.

According to a further arrangement positioning one or more further cells within the simulated virtual reality environment adjacent to the selected cell comprises animating the one or more further cells to transition from a first position to a final position that is further away from the selected cell than the first position. This helps direct the user to look towards the one or more further cells, and avoids disorientation that may be caused by cells suddenly appearing before the user.

The first position may be the position of the selected cell (or one or more selectable cells) or relatively close to the selected cell (or one or more selectable cells). The animation may result in the one or more further cells sliding from a first position (or a first yaw angle) to a second position (or second yaw angle). The sliding may be a smooth movement along a curved arc. Throughout the animation, the cells may maintain a constant distance away from user.

According to a further arrangement the method further comprises, in response to the direction of view of the user being directed towards a cell of the one or more selectable cells or the one or more further cells, distinguishing the cell from the other cells. This can help the user keep track of where they are looking, and can assist the user in selecting a given cell (e.g. by looking towards a cell and inputting a selection command).

Distinguishing the cell may comprise one or more of enlarging the cell, shrinking the cell, changing the colour of the cell, changing the shading of the cell, moving the cell or animating the cell. The system may determine that the direction of view is directed towards a cell in response to the direction of view passing through the cell (i.e. passing through the region occupied by the cell).

According to a further arrangement distinguishing the cell from the other cells comprises, in response to the direction of view of the user being directed towards one side of the cell, tilting the cell by moving the one side of the cell away from the user to provide feedback regarding the user's view within the graphical user interface.

Tilting the cell may comprise pivoting the cell about a central axis. The system may determine that the user is looking towards the one side of the cell by determining that the direction of view passes through a region that is located closer to the one side than the opposite side of the cell. The region may be the half of the cell closest to the one side or may be a region within a predefined distance from the one side.

According to a further arrangement the amount that the cell is tilted is increased as the direction of view moves away from an axis about which the cell is tilted. Direction of view moving away from the axis may involve an increase of distance between the axis and an intercept point between the direction of view and the cell. This distance may be measured along the shortest path between the intercept point and the axis—i.e. measured along a path perpendicular to the axis.

According to a further arrangement tilting the cell comprises pivoting the cell about a vertical axis passing through a central point of the cell. Accordingly, the one side may be a lateral or transverse side of the cell (in contrast to an upper or lower side of the cell).

According to a further arrangement the method comprises, in response to the selected cell being selected by the user, highlighting the selected cell. Highlighting may comprise emphasising or otherwise distinguishing the selected cell within the graphical user interface from the other ones of the one or more selectable cells. This allows the user to keep track of their previous selections.

According to a further arrangement highlighting the selected cell comprises one or more of changing the colour, changing the shading, moving, shrinking, enlarging or animating the selected cell.

According to a further arrangement the one or more further cells are selectable and the method further comprises, in response to a receipt of a user selection of one of the one or more further cells, positioning one or more additional cells within the simulated virtual reality environment adjacent to the one or more further cells. Accordingly, the user interface may continue to be built around the user, with any number of additional cells being positioned around the user. The additional cells may be similar to the further cells as described herein. For instance, they may be formed in column, at third yaw angle, with a changing gradient of shading or colouring, etc.

According to a further arrangement one of the one or more further cells is not selectable and a symbol is displayed over or adjacent to the one of the one or more further cells to indicate that it is not selectable. This indicates to the user that the end of the menu structure has been reached.

According to a further arrangement the symbol is a close button such that, when the close button is selected, the one or more further cells are closed. This provides an efficient mechanism for returning to a higher level within the user interface. If the one or more further cells are at third level or lower within the user interface, the system may close all cells below the first level. Alternatively, the system may close only the one or more further cells.

According to a further arrangement, in response to the close button being selected, the graphical user interface is moved within the virtual reality environment to position the one or more selectable cells in front of the user. This can provide a quick and efficient mechanism for returning the user to a higher level of the user interface. Positioning the one or more selectable cells in from of the user may comprise positioning the one or more selectable cells such that at least one of the one or more selectable cells has a central vertical axis that intersects with the direction of view. In one arrangement, instead of positioning the one or more selectable cells in front of the user, the system positions a top level of one or more cells in front of the user.

According to a further arrangement the graphical user interface includes a scrollable cell of the one or more selectable cells or the one or more further cells that contains scrollable content; and the scrollable content is scrolled upwards in response to the direction of view being directed towards a lower end of the scrollable cell or scrolled downwards in response to the direction of view being directed towards an upper end of the scrollable cell. This provides a simple and efficient means for more content to be presented within the scrollable cell than would normally fit within the cell.

The position of the scrollable content within the scrollable cell may be defined based on the intercept point between the direction of view and the scrollable cell. The scrolling may be scaled across the height of the scrollable cell. The scrollable content may be scrolled by an amount proportional to the position of the intercept point relative to the overall height of the scrollable cell. For instance, the distance of the intercept point from the top of the scrollable cell may be determined, the percentage of the distance relative to the total height of the scrollable cell may be calculated, and then this percentage may be used to determine a proportional amount of scrolling by defining a distance equal to the same percentage relative to the total height of the scrollable content.

A minimum threshold may be set to the scrolling wherein scrolling only occurs when the direction of view is changed by more than the minimum threshold. The scrolling may be divided into steps. The height of the scrollable cell may be divided into a set of equally sized strips from the top of the predefined region to the bottom of the scrollable cell. Each strip may relate to a range of distances from the top of the scrollable cell. The height of each strip may be equal to the total height of the scrollable cell divided by the number of steps. Each region may be associated with a corresponding amount that the scrollable content is to be scrolled relative to the previous region. This amount may be equal to the total height of the scrollable content divided by the number of steps.

According to a second aspect of the invention there is provided a system for providing a virtual reality graphical user interface, the system comprising a controller. The controller is configured to receive an input indicating a current direction of view of a user and generate and output a virtual reality simulation of the user's view of a simulated virtual reality environment for display on a virtual reality display, the virtual reality environment comprising the graphical user interface. The graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user. In response to receiving an indication of a selection of a selected cell of the one or more selectable cells, one or more further cells are positioned within the simulated virtual reality environment adjacent to the selected cell such that the graphical user interface is built around the user within the virtual reality environment.

According to a third aspect of the invention there is provided a computer readable medium comprising computer executable instructions that, when executed by a computer, cause the computer to receive an input indicating a current direction of view of a user and generate and output a virtual reality simulation of the user's view of a simulated virtual reality environment for display on a virtual reality display, the virtual reality environment comprising the graphical user interface. The graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user. In response to receiving an indication of a selection of a selected cell of the one or more selectable cells, one or more further cells are positioned within the simulated virtual reality environment adjacent to the selected cell such that the graphical user interface is built around the user within the virtual reality environment.

The arrangements described herein therefore provide an improved user interface for use within a virtual reality environment. In addition to the improved user interface, this application also discusses improvements in synchronising content within a virtual reality system and rendering content within a virtual reality system.

According to one arrangement there is provided a computer-implemented method for providing a graphical user interface for use in a virtual reality system, the method comprising a computing system: receiving an input indicating a current direction of view of a user; and, generating and outputting a virtual reality simulation of the user's view of a simulated virtual reality environment for display on a virtual reality display, the virtual reality environment comprising the graphical user interface. The graphical user interface comprises a scrollable region which content is presented within the virtual reality environment, the scrollable region being positioned within the simulated virtual reality environment at a fixed position within the virtual reality environment relative to a position of the user within the virtual reality environment, the fixed position being independent of the direction of view of the user. The size of the content is larger than the size of the scrollable region so that only a portion of the content is displayed within the scrollable region at one time. The content is scrolled within the scrollable region based on the direction of view of the user.

The content is scrolled within the scrollable region as the direction of view moves along one or more scrolling axes. The scrolling axes may comprise a horizontal axis and a vertical axis within the virtual reality environment. The scrolling may therefore be performed in one or more directions (e.g. horizontally and/or vertically).

The scrolling may be scaled so that the direction of view falling along a particular percentage along an overall extent of the scrollable region causes the content to be scrolled by an equivalent percentage along the overall extent of the content. The overall extent of the content or the scrollable region may be the height and/or width of the content or scrollable region.

The scrollable region may be divided into a predefined number of scrolling sections. Each section may define a set amount of scrolling relative to an adjacent section. The set amount of scrolling may be equal to the overall extent of the content divided by the number of scrolling sections.

For instance, the position of the content within the scrollable region may be defined based on the intercept point between the direction of view and the scrollable region. The scrolling may be scaled across the height (or width) of the scrollable region. The content may be scrolled by an amount proportional to the position of the intercept point relative to the overall height (or width) of the scrollable region. For instance, the distance of the intercept point from the top (or side) of the scrollable region may be determined, the percentage of the distance relative to the total height (or width) of the scrollable region may be calculated, and then this percentage may be used to determine a proportional amount of scrolling by defining a distance equal to the same percentage relative to the total height (or width) of the content.

A minimum threshold may be set to the scrolling wherein scrolling only occurs when the direction of view is changed by more than the minimum threshold. The scrolling may be divided into steps. The extent of the scrollable region along the scrolling axis (the height or width) may be divided into a set of equally sized strips from the one end of the scrollable region to the other. Each strip may relate to a range of distances from the top (or side) of the scrollable region. The height (or width) of each strip may be equal to the total height (or width) of the scrollable region divided by the number of steps. Each strip may be associated with a corresponding amount that the scrollable content is to be scrolled relative to the previous region. This amount may be equal to the total height (or width) of the scrollable content divided by the number of steps. The steps may be applied to both horizontal and vertical axes, wherein the two sets of strips form a grid-like structure.

According to one arrangement there is provided a method of synchronising virtual reality content with additional content for presentation in a virtual reality environment. The method comprises a computing system: obtaining a virtual reality video comprising a plurality of frames, each frame detailing a corresponding 360° view of a recorded environment and each frame having an associated frame number; obtaining one or more videos associated with the virtual reality video, each of the one or more videos comprising a set of associated frames associated with a respective frame number and comprising a position within the virtual reality environment at which the frames are to be displayed; receiving an input from a user instructing playback of at least the virtual reality video from a start point associated with a starting frame number; loading the frame of the virtual reality video associated with the starting frame number; loading, for each of the one or more videos associated with the virtual reality video, the associated frame associated with the starting frame number; and playing the virtual reality video from the starting frame number, wherein, for each of the one or more videos associated with the virtual reality video, the frames are played, at least in the background, as the virtual reality video is played, in order to maintain synchronisation of the one or more videos with the virtual reality video.

By playing frames in the background, synchronisation between the multiple videos may be maintained. Playing in the background may comprise computing the frames but not displaying them within the virtual environment.

The virtual reality video may be rendered on the inside surface of a sphere centred on a position of the user within a virtual reality environment. Each frame of the one or more videos may be rendered in on a flat surface (e.g. a window). Playing the one or more videos in the background may comprise loading or rendering the relevant frame but not displaying the frame within the virtual reality environment.

The method may further comprise displaying one of the one or more videos in response to an input indicating that the video is to be displayed. The input may be input from user, or an input of a predefined visibility value associated with the frames to be displayed.

The virtual reality video may have an associated audio feed that is played in conjunction with the frames of the virtual reality video. Each of the one or more videos may have their own associated audio feed that is played in the background at a reduced volume (e.g. muted). Played in the background may comprises loading and processing the audio for playing but muting the sound. In response to one of the one or more videos being displayed, the audio for the video may be mixed in with the audio for the virtual reality video.

According to a further arrangement there is provided a method of rendering a three dimensional model within a virtual reality environment. The method comprises a computing system: obtaining a pre-rendered video of a three dimensional model, the video having been rendered from a fixed perspective virtual camera at a predefined virtual distance; positioning a two dimensional plane primitive within a virtual reality environment at a set distance away from a user position; and rendering the video onto the two dimensional plane primitive within the virtual reality environment to provide the illusion that the three dimensional model is within the virtual environment.

This arrangement allows complex geometrical models to be animated and displayed within a virtual reality environment on a device with a restricted amount of processing power.

The video may be rendered with an alpha channel set to zero. In this case, the method may further comprise converting the alpha channel to a specific shade or colour (e.g. green) and removing the green pixels when the video is rendered in virtual reality.

In the arrangements described herein, rendering onto the primitive is performed by a shader. Advantageously, the plane primitive may be positioned within the virtual environment the set distance away from the user position. The set distance may be between 1 meter and 3.5 meters. The set distance may be 1 meter.

Any of the methods described herein may be implemented on a system configured to implement the respective method through a computer readable medium that causes a computer to implement the respective method.

### DETAILED DESCRIPTION

A virtual reality system is proposed herein for provide effective training for surgical trainees.

Virtual reality videos of surgical procedures are provided in a virtual reality interface that allows the user to view surgical procedures as if they were present within the operating theatre. Additional content such as video feeds (e.g. laparoscopic video feeds) may be displayed in real time within the virtual reality environment to provide additional detail to the trainee.

Three major components that are used to deliver a virtual reality training platform according to the present arrangements:
1) Content creation pipeline
2) Server-side entities
3) Client application (client app)

Content Creation Pipeline

In order to provide a virtual reality video of a surgical procedure, multiple 360° stereo linear cameras are placed within an operating theatre to record the surgical procedure as it is performed. The multiple video feeds are combined to provide one interactive virtual reality stream that can be viewed within the client app.

Traditional tripods are not appropriate for an operating theatre environment. Accordingly, a mounting system is utilised that allows the camera to be suspended from operating theatre lighting. This allows the camera to be held in a position above the surgery so that the actions of the surgeon can be effectively recorded.

During development of the virtual reality system, it was found that traditional audio recording techniques were not appropriate for an operating theatre environment. Accordingly, lapel microphones are used to capture the surgeon's voice during the operation. In addition, an ambisonic microphone is used to capture ambient sound. Both sound sources are mixed and synced within the client application.

Additional training materials are provided beyond the virtual reality streams of surgical procedures. A team of medical professionals has assisted in the creation of a template that forms the basis of each training modules.

A module consists of the following items:
Title (text)
Description (text)
Learning objectives (text)
Self-assessment (interactive question bank)
Slides (images)
360° video feed (with chapter selection)
360° video hotspots
Additional video feeds
Exam (interactive question bank)

In order to provide additional content such as text and to allow effective navigation between different types of content in virtual reality, it was necessary to develop an improved graphical user interface, as discussed below.

Server-Side Entities

Module content is stored on a server system that allows a user's client application to access the content.

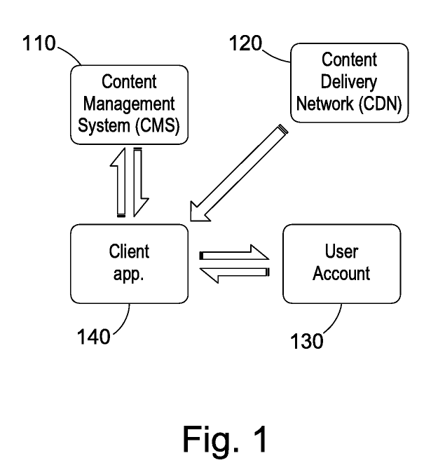

FIG. 1 shows how the server-side entities interact with the client application according to an arrangement.

The server-side entities include a content management system (CMS) 110, a content delivery network (CDN) 120 and a user account 130. The server-side entities are communicatively connected with a client application 140, for instance, via the internet. The server-side entities may be implemented on a single server or distributed across a number of servers.

The content management system 110 is a system for the creation and management of digital content. The content management system is run on a server. In one arrangement, a ‘Headless CMS’ method is used that vastly increases the speed of deployment. The database and query infrastructure may be abstracted into a “What You See Is What You Get” (WYSIWYG) interface. This allows the data layer to be designed visually. This tool was used to implement the module template and create an application programming interface (API) to access the content.

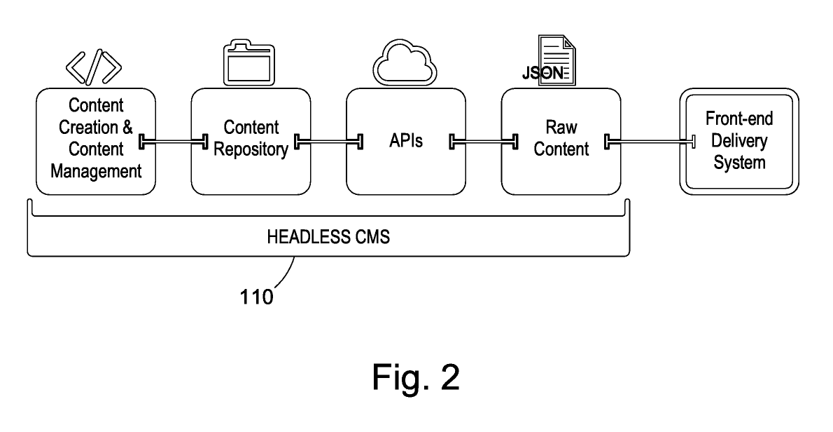

FIG. 2 shows an example of a content management system according to an arrangement. The content management system 110 comprises a content creation and content management module for creating and managing content. The content is then stored in a content repository. The raw content can be accessed via the application programming interface and transferred to the user using a front-end delivery system.

The content delivery network 120 hosts the content and transfers the content to the client application 140. In one arrangement, the video files are stored as adaptive bitrate video files to provide a more stable stream of content.

User account data 130 is stored on a server to enable account creation and maintenance.

The following information is stored:
First name
Last name
Date of birth
Gender
Country
Username
Email address
Whether or not the user is a medical professional
Password
Token count

Users are provided access to the content on a subscription basis. Users are able to purchase additional modules through the use of tokens.

Virtual reality provides difficulties when it comes to facilitating purchases. All existing payment approaches in mobile are fragmented with regards to virtual reality since there is a multiplicity of virtual reality platforms and hardware configurations. To address this, a subscription plus token solution is provided.

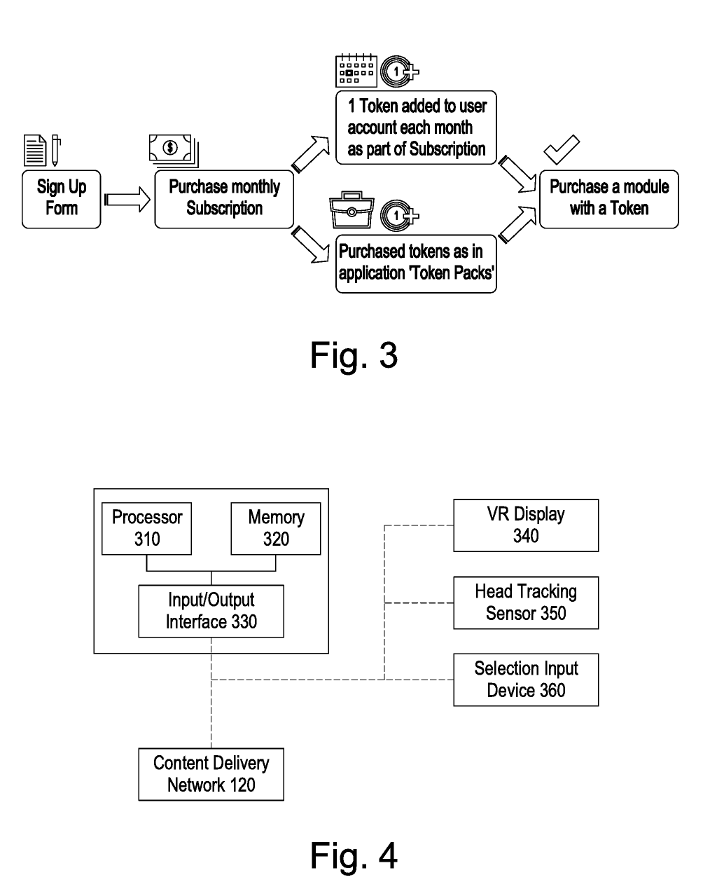

FIG. 3 shows a token purchase method for a virtual reality system. The method is based around a subscription service where token(s) are added each month and additional tokens can be purchased:
Users can join the platform for free with limited access to free modules
To access other paid content a user needs to obtain token
To obtain tokens a user must subscribe for a monthly fee. With this subscription a user receives a number of tokens (e.g. one) per month
If a user wants to obtain more Tokens, they can be purchased in packs
Each paid module costs a set number of tokens (e.g. one token)

This solution solves the VR payment in the following ways:
It is consistent—Regardless of which virtual reality (VR) platform a customer uses, purchased modules will be accessible. Similarly, since currency is abstracted into tokens, purchasing a new module presents the same user experience, regardless of the VR platform that is used.
It is user-friendly—the subscription plus token approach means that users have complete control over which modules they access. They do not have to pay for content that is not relevant to their learning objectives.
Reduced friction—in the current VR platform ecosystem, each platform has its own way to present transactions. Some require the user to exit the VR environment and complete the transaction in a traditional 2D interface. The present approach minimises the number of occasions when a user must interact with system-level payment gateways. Once a user has accrued tokens (e.g. via subscription or purchasing packs) then they can be exchange for modules with a seamless interaction that takes place entirely in VR.

Client Application

The client application runs on a virtual reality system to allow the user to access modules from the server-side entities and to view the modules in a virtual reality environment.

FIG. 4 shows an example of a virtual reality system according to an arrangement. The system comprises a processor 310 configured to generate a virtual reality environment according to instructions stored in memory 320. An input/output interface 330 is configured to output a virtual reality feed for display on a virtual reality display 340.

A head tracking sensor 350 tracks the position and orientation of the user's head so that the user's direction of view may be determined. Head tracking information is provided to the processor 310, via the input/output interface 330, so that the virtual reality feed can be updated in real time based on the user's direction of view. The user's direction of view can be represented as an axis passing through the centre of the user's field of view.

The virtual reality display 340 may be integrated into a headset that supports the display over the user's eyes. By providing a stereoscopic feed, a 3D representation of the virtual environment may be displayed to the user.

A selection input device 360, such as a hand-held controller, a keyboard, or a button (or other input means) mounted on the head mounted display, is provided in communicative connection with the input/output interface 330. This allows the user to make selections within a graphical user interface within the virtual reality environment.

The system is connected to the content delivery network via the input/output interface 330, for example, via the internet. This allows the system to download modules and content for presentation to the user. The input/output interface may be a single component, or may be separate input and output components.

The arrangement of FIG. 4 comprises a virtual reality system for generating and maintaining the virtual reality environment, and separate input and output devices, such as the virtual reality display 340 and head tracking sensor 350. This may be implemented, for instance, with a user's home computer acting as the virtual reality system, and a set of virtual reality peripherals that are connected to the computer. Alternatively, the system may be implemented in a mobile device, such as a smart phone. The memory and processor of the mobile device may perform the processing. A touch screen of the mobile device may act as the display 340, whilst an accelerometer may act as the head tracking sensor 350 and a button on the mobile device may act as the selection input device 360.

Many different technologies are available for head tracking. Some include tracking of the user's position within the environment, whereas others simply track the rotation of the user's head. In the present case, a simple model will be used wherein a local coordinate system is used that is centred on the user, but that is fixed with regard to rotation within the simulated environment. The user's direction of view can then be represented in terms of a set of rotations about axes centred on the user.

The rotations can be measured in terms of pitch, yaw and roll. Pitch represents a rotation about a horizontal axis (e.g. “east” to “west”). Roll represents a rotation about a horizontal axis that is perpendicular to the axis for pitch (e.g. “north” to “south”). Yaw represents a rotation about a vertical axis.

Graphical User Interface

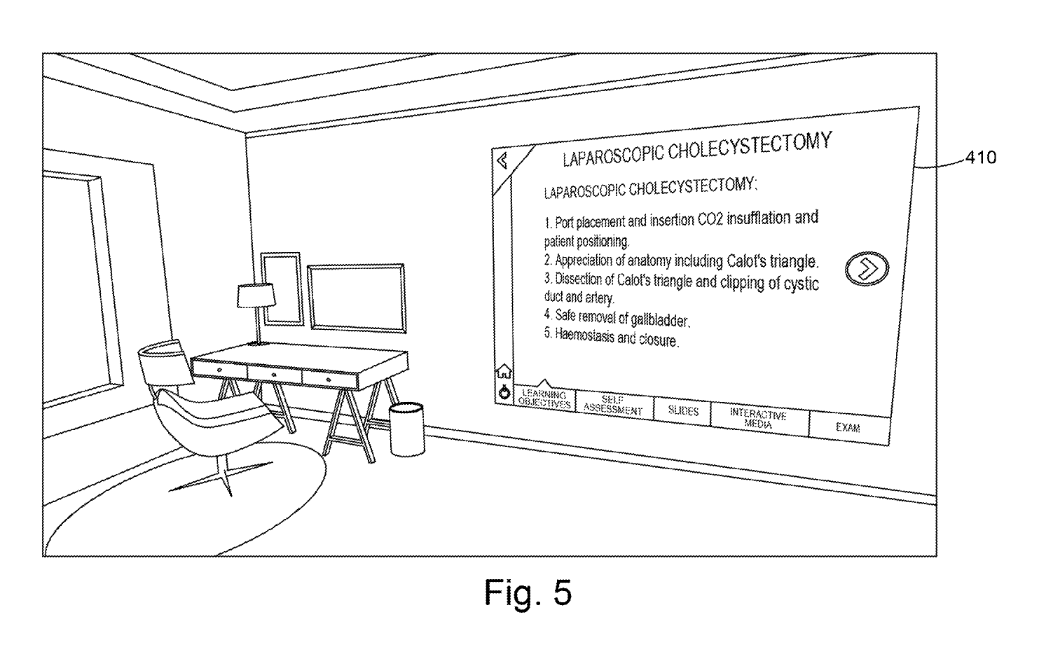

FIG. 5 shows an example of a graphical user interface for a virtual reality system.

The graphical user interface is presented in the context of a 3D virtual environment. In the present example, an office is displayed as this is a relaxing and familiar location. Real-time rendering is used to give a comforting depth and immersion. The user is free to look around the virtual environment, with the user's view of the environment being updated in real-time based on the user's direction of view.

A user interface 410 is mapped onto a wall within the environment. This gives the impression of a projection onto the wall, or a large screen computer interface. The interface comprises a number of tabs that may be selected, and a main window containing content. Due to the context of the environment design, the menu is instantly familiar. A user does not need to learn a new way to interact because the paradigm mirrors the real world.

The user may select categories for study using the selection input device. Each category comprises a list of modules falling within that category. Within a module, the user may select various learning objectives, self-assessment tests, slides, 360° interactive videos and examinations. Text and content can be displayed within the user interface as if it were projected onto the wall. When an interactive video is selected, a 360° video feed is played, with the user able to fully look around the environment (in this case, an operating theatre), and select additional content (e.g. close-up views, additional video feeds) during play-back.

The module template requires a pre-assessment test and exam to be completed. A custom algorithm compares the scores of users which in-turn provides feedback to validate the module.

Nevertheless, more can be done to provide an intuitive user interface that makes the most of the immersive aspects of virtual reality. When immersed in an entirely digital environment it is possible to become lost or confused when navigating a complex menu structure. The following description details an improved user interface for virtual reality that makes user of the user's spatial awareness to help the user keep track of their position within the menu hierarchy.

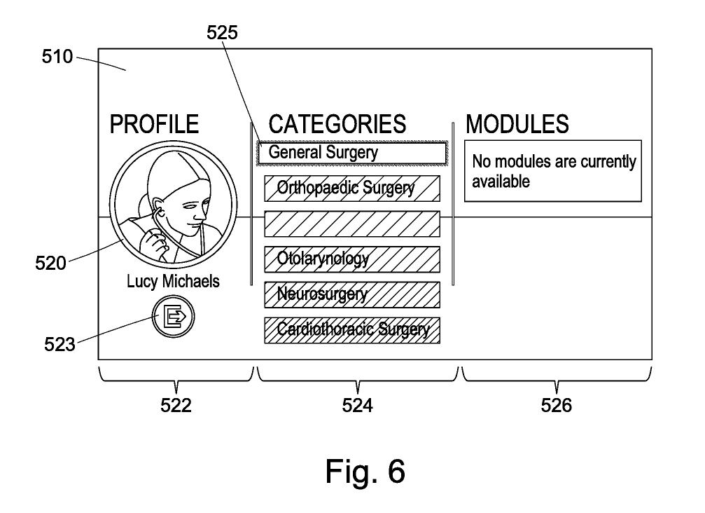

FIG. 6 shows a first view of an improved user interface according to an arrangement. The user interface is positioned within a virtual environment at a set distance away from the user (e.g. projected onto the inner surface of sphere centred on the user). A background environment 510 is displayed to provide an immersive experience and to create a contrast with the user interface.

The user interface includes a number of vertical columns 522, 524, 526, each containing a set of one or more cells 520. The cells 520 are objects presented within the graphical user interface and may be selectable or non-selectable. The cells may be, for instance icons, windows and/or text boxes. The columns are built side-by-side in a ring around the user at various set angles (yaw angles—measured around the vertical axis relative to a fixed coordinate system within the virtual reality environment). The columns are located at fixed locations around the user within the virtual environment. This allows the user to associate different directions of view with different positions within the menu structure.

The user interface has a hierarchical structure. A number of initial columns are presented when the user first enters the user interface. In this case, a profile column 522 and a categories column 524 are displayed. As the profile column 522 and categories column 524 are presented first, these are the highest level of the user interface. As the user makes selections within the interface, they navigate to lower levels representing more specific content.

The user interface is initially centred on the yaw axis of the user's direction of view when the application is opened. For instance, in the present case, the categories column 524 may be centred on this yaw axis. After this point, the user interface is static within the virtual environment. Accordingly, the user can turn to view various aspects of the user interface without the user interface moving within the virtual environment (although, the user's view of the user interface changes).

The profile column 522 is an “anchor” element that represents the start of the user interface. The profile column 522 includes the user's name, an image of the user and an exit button 523 to allow the user to close the application.

To the left of the anchor column is a column of user centric cells (not shown). These include cells for:
Account—a user can access account information, including their current subscription terms
Trophies—rewards earned for completing various objectives within the platform are visualised here
Store—an online store where users can buy additional tokens

The categories column 524 includes a number of selectable cells 525 listing the various categories of modules that are available.

A category may be selected, for instance, by the user using “up”, “down” and “select” buttons on the selection input device 360. Alternatively, a category may be selected based on the user's direction of view by the user looking towards the desired category and selecting the category via the selection input device 360 (e.g. via a “select” button). Optionally, a cursor may be placed at the centre of the user's field of view.

When one of the cells is selected, a second column is displayed adjacent to the column containing the selected cell. This column represents the next level down in the hierarchical structure. Further selection can be made in this column, and further columns can be displayed for further levels down. Accordingly, a deep hierarchy of information can be “built” around the user within the virtual environment, ensuring that they are highly aware of their position within the menu structure.

Each time a new column is added based on a user selection, an animation may be utilised to avoid disorienting the user. Accordingly, when a cell is selected from a first column, any new cells may slide out from the first column to form a new column. This sliding motion helps to direct the user towards the new column that is formed from new cells and also helps to prevent the user becoming disorientated by having a number of cells appear in front of them within the virtual environment.

The sliding action may be implemented by moving the cells in the new column from a position within the column containing the selected cell to a final position forming the new column. Where there is overlap between the new cells and the first column, the new cells may be at least partially occluded by the cells in the first column or by the first column itself. This can produce the effect of cells sliding out from behind the first column. The cells may move along a path around the user maintaining a constant distance from the user.

In the present case, a module column 526 is displayed next to the categories column 524 when one of the categories is selected. The module column 526 includes a list of cells that represent the various available modules within the selected category. In the example of FIG. 5, the “General Surgery” category has been selected. In this case no modules are available for this category. Accordingly, a cell is displayed informing the user that no modules are currently available for the selected category.

By providing a hierarchical user interface structure that is built around the user, the user can navigate quickly between various menu hierarchies. The user can quickly jump back to view earlier selections and make alternative selections at higher levels of the structure without having to close or otherwise specifically navigate back through the structure. This can be achieved simply by the user turning their head to view the earlier columns in the user interface through which the user has navigated.

For instance, if the user wishes to change category, they can turn their head to view the categories column and select an alternative category without having to close the current module tab/column. Equally, the user can quickly exit the application without having to close the module and category tabs/columns.

Even if the user does not wish to navigate away from their current position within the hierarchy, keeping the various levels open around the user allows the user to easily reacquaint themselves with their position within the hierarchy without closing or navigating away from any levels or selections.

When a cell is selected, it is highlighted to allow the user to see the path through the user interface through which they have navigated. In this case, the highlighting includes changing the colour of the selected cell and enlarging the selected cell. This helps the user to keep track of their past progress through the interface. When the selected cell is enlarged, a shadow effect is also applied around the selected cell to give the impression that the selected cell has been lifted from the column, towards the user.

Where a column of cells includes a plurality of cells, the cells may be shaded and/or coloured with a gradient that changes down the length of the column. This allows the user to easily determine whether they are looking towards the bottom or top of a given list of cells. The gradient may get darker as the list descends down the column, or may get lighter as the list descends. Differing columns may also be shaded and/or coloured differently to allow the user to easily differentiate the columns and quickly determine where they are within the hierarchy.

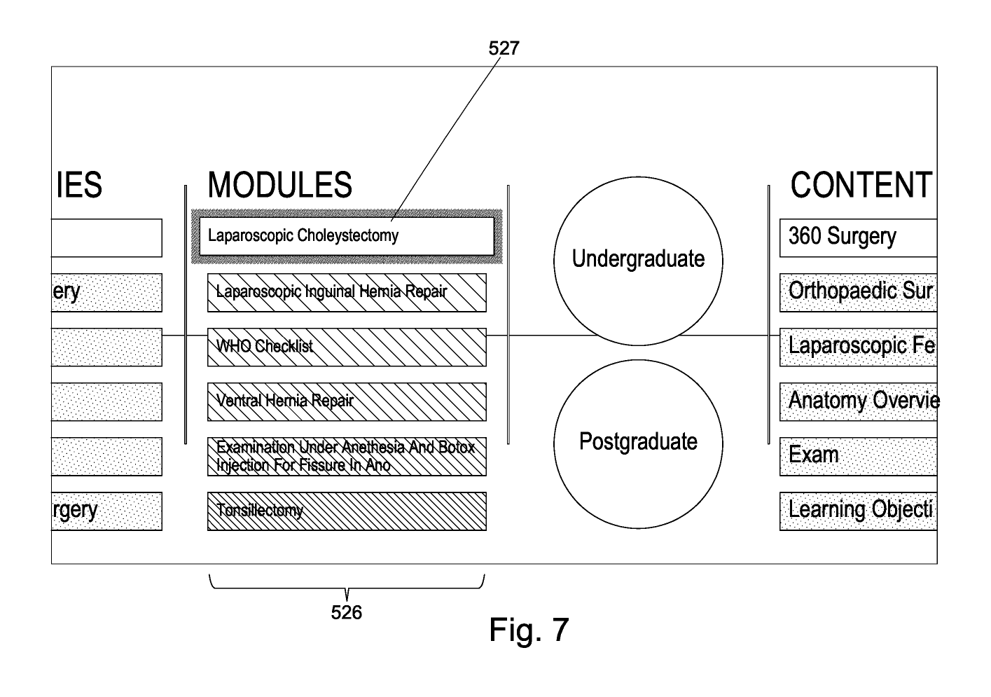

FIG. 7 shows a second view of the user interface of FIG. 5. In this case, the user has selected a category that includes available modules. The available modules are therefore displayed in a similar column format to that of the categories column, with a changing gradient down the length of the column. As discussed, the modules column 526 is coloured differently to the categories column 524. In one arrangement, the modules column 526 is coloured red and the categories column 524 is coloured blue.

As with the categories column 524, when a user selects a module, an additional column is added adjacent to the modules column 526 and the selected cell 527 is highlighted by enlarging it and changing its colour. In this case, the user is presented with a choice of undergraduate or postgraduate content. Upon selection, a content column is presented adjacent to the undergraduate/postgraduate column.

Accordingly, as the user navigates from higher, more general levels to specific content within the user interface, columns of selections/cells are built around the user. By building the user interface in a 180° ring around the user, the user can maintain an awareness of their position within the user interface based on their spatial awareness within the virtual environment. As the various levels of the hierarchical structure are continually presented to the user, the user can quickly jump from a lower, more specific level to higher levels without having to navigate through or close any of the cells.

Not all cells need be selectable. Some cells may include specific content, for instance, text or images. It can be helpful to the user if user interface distinguishes the selectable cells from the non-selectable cells.

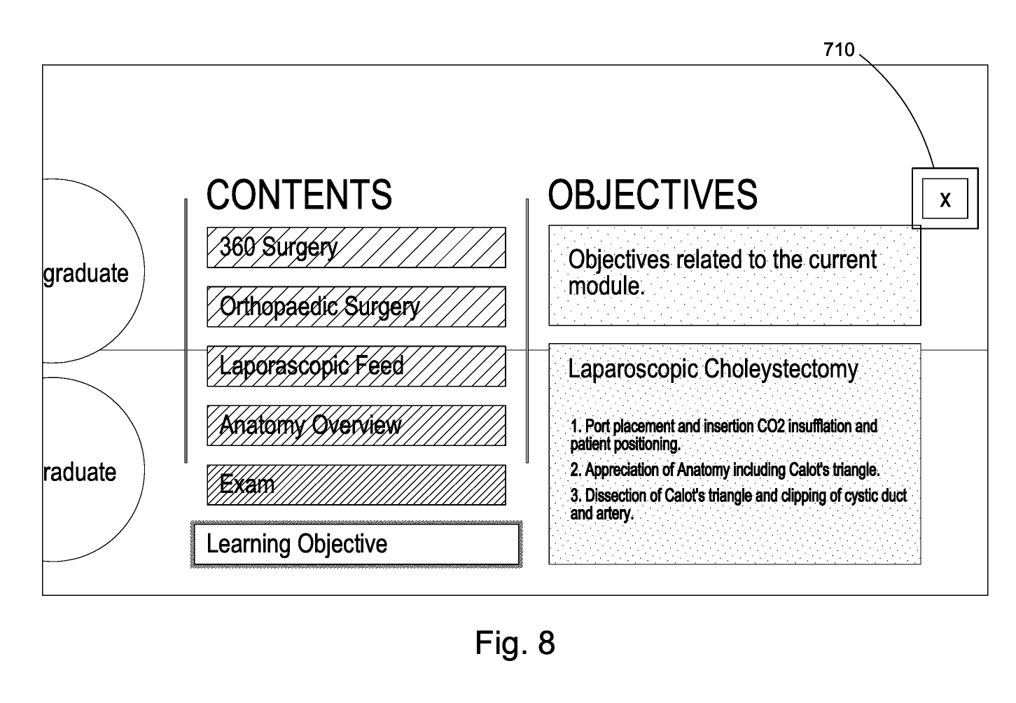

FIG. 8 shows a third view of the user interface of FIG. 6. In this case, the user has navigated down to the contents column and selected the “learning objective” cell. An “objectives” column is presented adjacent to the contents column. The objectives column includes a number of non-selectable cells in the form of text boxes containing text detailing the learning objectives for the selected module.

The objectives column contains non-selectable cells. It therefore represents the end of this particular branch of the user interface hierarchy, as a user cannot descend any further. Accordingly, an icon 710 is presented to the user indicating that the cells are non-selectable and therefore that the end of this branch of the user interface has been reached. The user is then free to select an alternative selection from the higher levels of the hierarchy.

Whilst not essential, in one arrangement the icon 710 is a close button. The icon 710 may therefore be selectable in order to close at least the most recently opened column. In one arrangement, only the most recently opened column (the column containing the non-selectable cells) is closed. Alternatively, the close button may function as an efficient means to return the user to the top level of the menu structure.

Whilst the user can turn back to the top level by turning their head to face this level, it can be easier to offer this functionality to allow the user interface to be re-centred. In this case, all of the previous selections made by the user are closed and user interface is rotated to centre itself on the user's current viewpoint. This would lead to the highest level of the user interface (the columns that are initially opened when the application is opened) being positioned in front of the user (i.e. set to the current yaw angle of the user's direction of view).

The user interface includes further features to help keep the user navigate effectively through the menu structure. In one arrangement, to allow the user to maintain an awareness of where they are looking within the user interface, the cells react to the user's current direction of view.

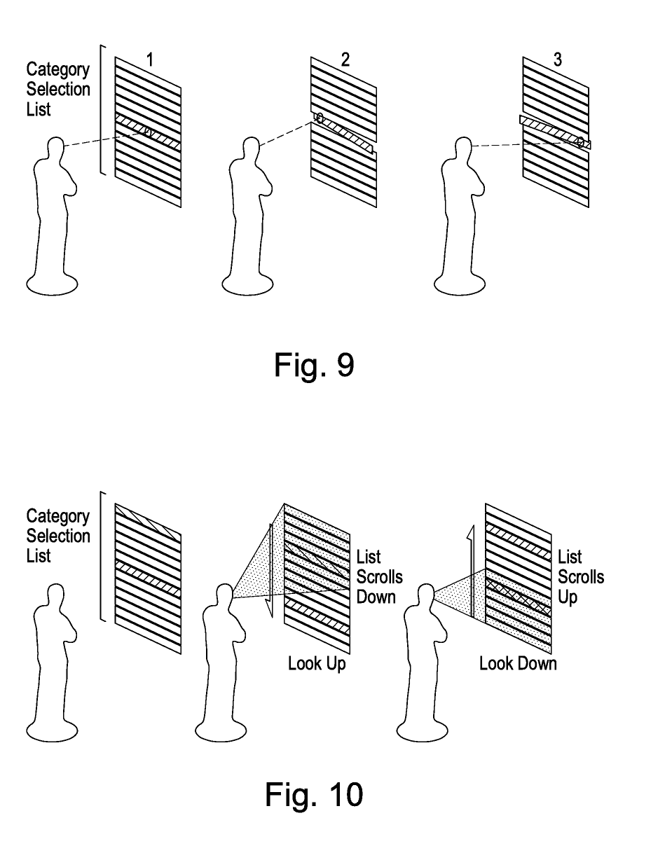

FIG. 9 shows how the cells react to the user's changing direction of view according to an arrangement. When the direction of view intercepts a particular cell, the cell moves to indicate this. This can help to distinguish the cell at which the user is looking from the other cells and is particularly useful in the situation where the user can make selections based, at least in part, on their direction of view (for instance, by looking at a specific cell and inputting a “select” input). Whilst FIG. 9 shows the user looking towards the category selection list, this functionality may apply to any type of cell or column of cells.

In the arrangement of FIG. 9, each cell also rotates based on the direction of view. If the user looks towards one side of the cell, the cell rotates to move that side away from the user, and to move the opposite side towards the user. This helps to provide feedback to the user regarding their current direction of view.

In the present arrangement, the amount of rotation increases as the direction of view moves further away from the centre of the cell (as a direction of view approaches the edge of the cell). Accordingly, the amount of rotation is determined by the offset of the user's direction of view from the central vertical axis of the cell. If the user looks directly at the centre of the cell (or if the user looks away from the cell), then the cell faces directly towards the user.

The term “looking towards one side of the cell” is intended to mean that the direction of view intercepts the cell at a point that is closer to one side of the cell than the opposite side of the cell. In the present arrangement, the cell is rotated around a vertical axis passing through the centre of the cell. Accordingly, the cell reacts to the user changing their direction of view along the horizontal axis. The cell does not react to any change in the direction of view along the vertical axis.

The user interface also provides an effective means of displaying a large amount of text or a long list of items or cells.

FIG. 10 shows a scrolling functionality of the present arrangement. The system is configured to scroll content based on the user's direction of view. In the arrangement of FIG. 10, the user is looking towards content in the form of a category selection list. Category selection list is too large to be displayed fully before the user. Accordingly, only a portion of the content is displayed in a scroll area (e.g. a column) before the user. The scroll area is a region within which content may be scrolled.

The system tracks the user's direction of view and scrolls the content based on whether the based on where within the scroll area the user is looking. The position within the scroll area of the intercept between the direction of view and the scroll area forms the basis for the control of the scroll functionality.

To reduce the amount that the user has to move their head, the content is scrolled by converting a given position within the scroll area to a given position within the overall content. Accordingly, the intercept point is located half way down the scroll area, the content is scrolled to a position half way down the full length of the content. This provides smooth and intuitive scrolling whilst avoiding the need for the user to make exaggerated movements to scroll the content (which can cause fatigue over time).

When the content is scrolled upwards, the content moves upwards within the scroll area. In this case the content comprises a category selection list. When a portion of the content moves past the top of the scroll area, that portion is no longer displayed. New portions of the content are displayed at the bottom of the scroll area as they enter the scroll area.

The opposite applies when content is scrolled downwards. In this case, the content moves downwards within the scroll area. When a portion of the content moves past the bottom of the scroll area, that portion is no longer displayed. New portions of the content are displayed at the top of the scroll area as they enter the region.

The scroll area can be considered a window displaying a portion of a larger set of content, although the explicit boundaries of the window need not be displayed. The content has a set area, the content area, with its own coordinates. The scroll area has a set area with its own coordinates. Both coordinate systems have origins at the top left hand corner of their respective areas (from the perspective of the user). The area of the scroll area is smaller than the content area.

When the user is not looking directly towards the scroll area (the direction of view does not intersect the scroll area), the content is positioned in a default position. In the present example, the default position is the scroll area being fully scrolled to the top of the content. This aligns the top of the content with the top of the scroll area (aligns the origins of the content area and scroll area).

When the direction of view intersects the scroll area, the system determines the coordinates of the intersection point between the direction of view and the scroll area. The coordinates (for instance, x and y coordinates) detail the location of the intersection point within the scroll area. For the purposes of up/down scrolling, only the y coordinate (the height of the intercept point) is considered, the x coordinate is ignored; although, the scrolling techniques described herein may equally be applied to sideways scrolling.

The system converts the y coordinate into a percentage of the total height of the overall scroll area. This provides a value that details the extent that the user is looking down the scroll area. The content is scrolled by a percentage equal to the extent that the user is looking down the scroll area. For instance, if the user is looking halfway down the scroll area (at a height of 50%) then the content is scrolled by 50% of the total length of the content. To achieve this, the percentage is converted into a distance equal to the percentage when applied to the total length of the content. The content is then translated within the scroll area to position the content at the position to achieve the determined overall scroll distance.

For instance, in one arrangement a scroll area of 500×500 pixels is used to display content with a total size of 500×1000 pixels. When the user is looking at the centre of the scroll area (50% down the scroll area) the intercept point will be located at the coordinates (250,250) in the scroll area. To scroll the content an equivalent amount (50%) up, the content is moved by 50% of 1000 pixels, which is equal to 500 pixels.

By applying the above method of scrolling, the size of the content is mapped to a smooth scrolling response across the entirety of the scroll area. This allows the entirety of the content to be viewed as the user moves their direction of view down the length of the scroll area.

If the scrolling was mapped to the head motion directly, then there is a risk that the content would scroll continuously in response to small changes in head motion, therefore making the content difficult to view. To overcome this problem, a minimum threshold for changes in viewpoint is set. The content only scrolls if the direction of view changes by more than the minimum threshold either upwards or downwards (i.e. if the absolute value of the change in viewpoint upwards or downwards exceeds the minimum threshold).

To achieve this, the height of the scroll area is divided up into a number of quantized steps. Each step can be considered a region within the scroll area (or a range of y coordinate values within the scroll area). When the intercept point falls within a specific region, the content is scrolled by a predefined amount associated with that region. This applies a minimum threshold for movement between steps.

The threshold is the height of the scroll area divided by the desired number of scrolling steps (the step primer):

$$Threshold = \frac{scroll area height}{step primer}$$

The step primer is tuned for the window and content to achieve a smooth scrolling motion whilst avoiding unintended scrolling from small head movements.

For each step the content is scrolled by a predefined amount. The distance that the content is scrolled per step is equal to the step size:

$$step size = \frac{content height}{step primer}$$

For instance, in the present arrangement scroll area is 500 pixels high, the content height is 1000 pixels high and the content is divided into 50 discrete regions. This sets a threshold of 10 pixels and a step size of 20 pixels. When the intercept point is located 100-120 pixels from the top of the scroll area, the intercept point occupies the 6^{th} step. Accordingly, the content is translated 6×20 pixels up relative to the default position. This would move the top of the content area 120 pixels above the top of the scroll area.

By automatically scrolling content based on the user's direction of view, an increased amount of information may be presented to the user effectively within the user interface in an organic manner.

Whilst FIG. 10 shows the scrolling of a category selection list, this functionality may be applied to any long type of content that would not normally fit within a required space, e.g. any column of cells, or content within a cell, such as text within a text box.

Combining the above features of the user interface, specifically the horizontal/vertical cell layout and the self-scrolling content, provides a menu system that can effectively (and gracefully) scale infinitely. This means that however large the menu hierarchy becomes, the user interface will be accommodating.

Pre-rendered stereo imagery for the background environment may be utilised. Since there is no geometry, the user interface is not confined spatially. Pre-rendering the environment also allows for a higher visual quality, increasing the aesthetics of the system.

Virtual Reality Content Synchronisation

In addition to the improved user interface described herein, the present system provides improvements with regard to the synchronisation of audio and video content within a virtual reality video.

When the user selects a virtual reality video to view, the selected virtual reality video is played to the user. As a virtual reality video is a 360° view, the user is able to look around to see different views within the recorded environment. The virtual reality video therefore takes the form of a virtual reality environment into which the user is placed.

It can often be desirable to provide additional content in addition to the virtual reality video. This additional content may be alternative perspective views within the recorded environment, or additional text, video or audio content. For instance, during a virtual reality video of a surgical procedure, it can be helpful to provide a video stream of another part of the surgery at the same time, for instance, in a pop-up window. An example of such a video could be a laparoscopic feed that plays synchronously with the virtual reality video of a surgeon performing a laparoscopic procedure.

It can be difficult to ensure that audio and video is synchronised between multiple videos playing at the same time, particularly in a virtual reality environment. The following description shall explain how this synchronisation is achieved in an efficient and effective manner.

To provide a virtual reality video, the relevant 360° video feed is rendered, frame by frame, onto a reversed poly-spherical primitive. That is, a two-dimensional spherical surface is placed around the user's location within the virtual reality environment. The two-dimensional spherical surface faces towards the user to form a surface upon which the video feed may be rendered. This ensures that the 360° video surrounds the user so that different views are presented depending on the user's direction of view.

As each frame is rendered, a publicly gettable floating-point variable ‘X’ is incremented. This provides a measure for time within the 360° video.

An array of media items ‘M’ is populated with the other video files ‘Vf’ that relate to the 360° video. These other video files can represent additional content that may be presented to the user in a pop-up window during the playback of the 360° video.

Each media item has a publicly settable floating-point variable ‘Y’. This value represents the time (in the 360° video) at which the media item begins. Each ‘Vf’ is rendered to a proportionally sized rectangular plane.

When a user initiates 360° playback, either via pressing ‘Play’ or choosing a chapter title, all content items associated with the 360° video (all items in ‘M’) are triggered to play with a ‘Y’ value equal to ‘X’. That is, the frame count for each media item is set to be the same as (synchronized to) the frame count of the 360° video at the beginning of playback.

A secondary algorithm recursively inspects a chapter metadata XML file (obtained from the server) to ascertain:
A. The three-dimensional coordinates of each frame for each content item (each ‘Vf’ plane in ‘M’). Each ‘Vf’ plane can then be relocated to the relevant position with the reversed-poly spherical primitive creating a rich layer over the 360° content.
B. The visibility value of each ‘Vf’ given the current value of ‘X’. Within the metadata XML visibility is expressed as a range. The algorithm performs a pre-frame comparison to enable or disable ‘Vf’ plane visibility based on the visibility value. If the visibility value is above a predefined threshold, then the video is displayed, otherwise, it is hidden.

In most cases, the content items are synchronised and played in the background but not displayed initially due to them having a visibility value indicating that the relevant content items are invisible. Each content item will then be displayed when the visibility has been toggled to visible. This may be due to a predefined frame at which the content will become visible, or due to the user inputting commands to make the content visible.

By playing the video is in the background without making them visible, synchronisation can be maintained and no time is required to retrieve and synchronise the content when the user requests that it be displayed. By “playing” a video in the background, it is meant that the video is computed but not displayed.

This also avoids any delays in displaying a video when selected caused by the need to retrieve the videos. In many arrangements, the videos streamed over the internet. Accordingly, loading the videos in the background can result in the videos being effectively buffered within memory. Having said this, delays can still be avoided where the videos are stored locally, as delays may be caused by delays in reading the data from memory or rendering the data once accessed.

When a ‘Vf’ frame is positioned and visible it will therefore be in-sync with the master 360° video.

Audio is also synchronised for the additional video content items. The master 360° video and each item in the ‘M’ array has its own audio feed embedded into the video. The audio associated with the master 360° video feed is played as the frames of the 360° video feed are played. The audio associated with each of the additional video feeds is played in the background, with the volume lowered (e.g. muted). This allows the synchronisation of the audio feeds to be maintained.

When a user activates an additional video stream ‘M’, the audio volume of ‘M’ is dynamically boosted while simultaneously the volume of the master 360° is lowered. This process may occur gradually over a period of time, e.g. 2 seconds. The audio levels of all video files are mixed to similar levels in order to prevent discomfort to the users.

If any audio or video pauses due to the need to download additional content (i.e. buffering), then the remaining video and audio feeds will continue to play, and the paused content will be resynchronised when buffering has been completed. The resynchronisation includes setting selecting the frame of the resynchronised content that is equal to the current frame count of the 360° video feed.

Object Rendering in Virtual Reality

In addition, it may be necessary to render and animate three-dimensional models within a virtual reality environment. For instance, in the surgical training system described herein, the user has the option of viewing a 3D model of the human anatomy. Such modelling can be computationally expensive in a virtual reality system. This can be problematic if the virtual reality system is running on a device with reduced processing capabilities, such as a mobile device.

To solve this problem, the arrangements described herein implement a 3D illusion technique wherein 3D geometry is animated and rendered onto a 2D surface, thereby reducing the amount of data that needs to be transferred to and processed by the client device.

A 3D model is generated and animated. In this case, a 3D anatomical model is produced. The animation should include at least rotation through a vertical axis to allow the user to view the model from multiple different angles.

The model is rendered with the following properties:
A. Rendered from a fixed perspective camera (non-animating).
B. Rendered at a virtual distance, and using a virtual lens, that mirrors that of the VR camera within the client application.
C. Rendered as series of TIFF images (although other image formats may be used).
D. Rendered with an alpha channel set to 0.

The rendered image sequence is further modified to convert the alpha channel into a specific colour. In the present arrangement, a specific hue of green is used, as this is easier to remove at a later processing stage. Any colour may be utilised provided that it has a high contrast compared to the other content within the video.

Within a fully 3D geometric environment a 2D plane primitive is positioned roughly 1.5 meters away from the virtual reality camera. Generally, it has been found that a distance of 1-3.5 meters (and 1.5 meters in particular) is effective in virtual reality.

A video render shader is assigned to the primitive. When the scene containing the single-plane 3D illusion initialises, send frames are sent from the prepared video file to the video shader where:
A. the video is rendered; and
B. the coloured pixels previously associated with the alpha channel are removed.

Accordingly, the illusion from a non-parallaxing VR camera is that of a fully 3D geometric entity within the room; however, the full rendering of a 3D geometric model is avoided. This allows complex modelling to be displayed to the user on a device with reduced computational power (e.g. a mobile device).

Hotspot Utility

Additional content may be accessed by the user by interacting with a “hotspot” within the video. A hotspot is an interactive element that is positioned within the virtual environment. The interactive element may be an icon or button. When a hotspot is selected, the system may either perform a predefined action (e.g. display text or play a video associated with the hotspot) or present the user with the option to view additional content associated with the hotspot.

Various types of hotspot may be added to a video. A hotspot may display text or may display additional video content. Hotspots that play video content are referred to as “videospots”. If a videospot is selected, the video associated with the videospot will be played to the user. The video may be displayed in a window occupying a predefined position within the virtual environment. The user may select the window and uncouple the window from the environment. The window will then stop being fixed within the virtual environment, and will instead follow the user's view. The window will occupy a fixed position within the field of view of the user.

A Hotpot Utility tool has been developed to allow easy placement of temporal interactive regions within a 360° video.

The basic operation is as follows:
1. A user chooses a 360° video file to which a hotspot is to be added.
2. Using the browser window, a user can navigate the 360° video to locate a position for the hotspot or locate a hotspot to be edited or deleted.
3. An onscreen GUI allows the user to add, edit or delete hotspots.
4. When adding or editing a hotspot the user can choose a start time, end time and what (if anything) should be displayed when the hotspot receives an interaction event.
5. Finally, a user exports a custom file that is uploaded to the CMS for disbursement.

The tool also allows users to create the chapter file using a timeline.

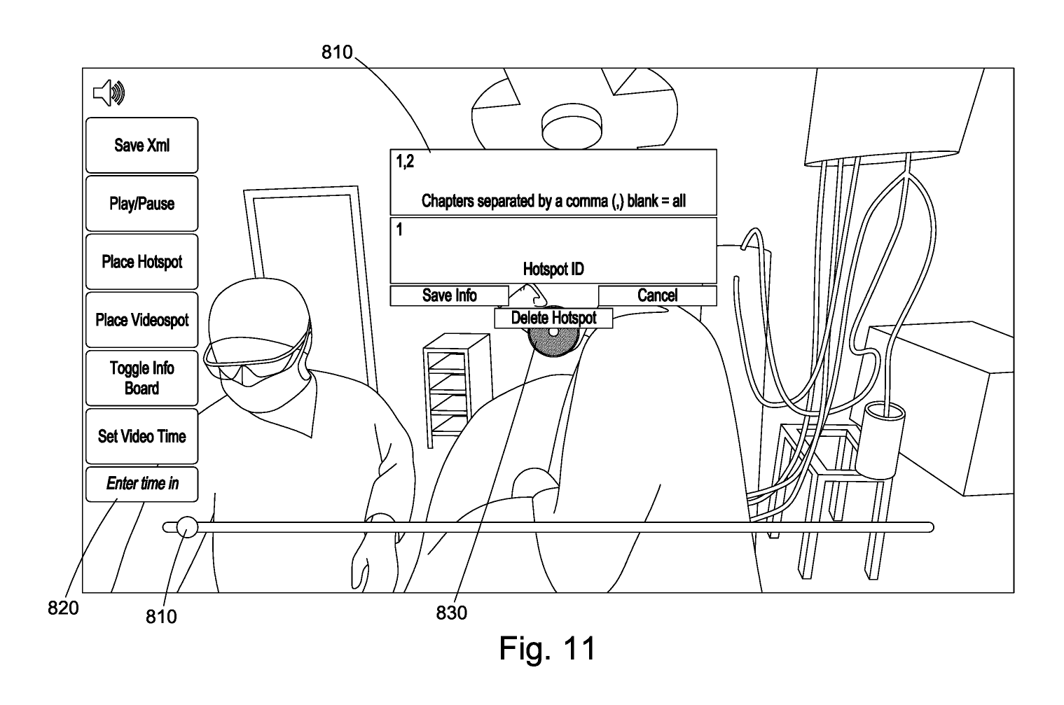

FIG. 11 shows an example of a user interface for adding hotspots to a virtual reality video. A 360° video is played in a virtual environment. A time indicator 810 is displayed to provide an indication of how much of the video has been played so far. A menu 820 is displayed to allow the user to select various actions including:
1. Play/pause the video.
2. Place a hotspot (at the current centre of view).
3. Place a videospot (at the current centre of view).
4. Toggle info board—displays/hides the info board. The info board is the user interface for editing the hotspots. By toggling the info board, the system can swap between a hotspot editing mode and a preview mode, where only the hotspots and the 360° video are shown.
5. Set video time—allows specific time within video to be input.
6. Save xml—save the details of the current hotspots.

If a hotpot has been placed, an icon 830 will be displayed at the location of the hotpot. When a hotspot is selected, a number of windows 840 will be displayed to allow the user to edit or delete the hotpot. The user may set a hotspot ID, may select chapters within the video, may save the current hotspot configuration, may cancel the editing of the hotspot (and therefore close the windows 840) or delete the hotspot.

Various arrangements have been described that provide improved virtual reality user faces and improved means of synchronising video and audio content within a virtual reality environment.

While the above arrangements are described primarily with the view of providing surgical training, the teachings of the present application may be equally applied to any virtual reality system, be that for training or otherwise.

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for providing a graphical user interface for use in a virtual reality system, the method comprising a computing system:
receiving an input indicating a current direction of view of a user; and,
generating and outputting a virtual reality simulation of the user's view of a simulated virtual reality environment for display on a virtual reality display, the virtual reality environment comprising the graphical user interface;
wherein the graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user; and
wherein, in response to receiving an indication of a selection of one of the one or more selectable cells, one or more further cells are positioned within the simulated virtual reality environment adjacent to the selected cell such that the graphical user interface is built around the user within the virtual reality environment.

2. A method according to claim 1 wherein:
the one or more selectable cells are positioned within the virtual reality environment at a first yaw angle about the user relative to a fixed coordinate system; and
the one or more further cells are positioned at a second yaw angle about the user relative to the fixed coordinate system, wherein the second yaw angle is different to the first yaw angle.

3. A method according to claim 2 wherein:
the one or more selectable cells comprise a plurality of selectable cells arranged vertically in a column at the first yaw angle; and
the one or more further cells comprise a plurality of further cells arranged vertically in a column at the second yaw angle.

4. A method according to claim 3 wherein one or both of the columns of selectable cells and the column of further cells is shaded or coloured with a gradient that changes along a vertical axis to provide feedback to the user regarding their view within the graphical user interface.

5. A method according to claim 3 wherein the column of selectable cells has one or more of a shading or colouring that is different to the column of further cells to provide feedback to the user regarding their view within the graphical user interface.

6. A method according to claim 3 wherein:
the one or more further cells form part of a set of further cells;
the one or more further cells are displayed within a predefined region within the virtual reality environment; and
in response to the direction of view being directed towards the top of the region, the further cells within the column are scrolled downwards within the predefined region to present additional cells from the set of further cells, or
in response to the direction of view being directed towards the bottom of the region, the further cells within the column are scrolled upwards within the predefined region to present additional cells from the set of further cells.

7. A method according to claim 1 wherein positioning one or more further cells within the simulated virtual reality environment adjacent to the selected cell comprises animating the one or more further cells to transition from a first position to a final position that is further away from the selected cell than the first position.

8. A method according to claim 1 wherein the method further comprises:
in response to the direction of view of the user being directed towards a cell of the one or more selectable cells or the one or more further cells, distinguishing the cell from the other cells.

9. A method according to claim 8 wherein distinguishing the cell from the other cells comprises:
in response to the direction of view of the user being directed towards one side of the cell, tilting the cell by moving the one side of the cell away from the user to provide feedback regarding the user's view within the graphical user interface.

10. A method according to claim 9 wherein the amount that the cell is tilted is increased as the direction of view moves away from an axis about which the cell is tilted.

11. A method according to claim 9 wherein tilting the cell comprises pivoting the cell about a vertical axis passing through a central point of the cell.

12. A method according to claim 1 wherein the method comprises, in response to the selected cell being selected by the user, highlighting the selected cell.

13. A method according to claim 12 wherein highlighting the selected cell comprises one or more of changing the colour, changing the shading, moving, shrinking or enlarging the selected cell.

14. A method according to claim 1 wherein the one or more further cells are selectable and wherein the method further comprises:
in response to a receipt of a user selection of one of the one or more further cells, positioning one or more additional cells within the simulated virtual reality environment adjacent to the one or more further cells.

15. A method according to claim 1 wherein one of the one or more further cells is not selectable and wherein a symbol is displayed over or adjacent to the one of the one or more further cells to indicate that it is not selectable.

16. A method according to claim 15 wherein the symbol is a close button such that, when the close button is selected, the one or more further cells are closed.

17. A method according to claim 16 wherein, in response to the close button being selected, the graphical user interface is moved within the virtual reality environment to position the one or more selectable cells in front of the user.

18. A method according to claim 1 wherein:
the graphical user interface includes a scrollable cell of the one or more selectable cells or the one or more further cells contains scrollable content; and
the scrollable content is scrolled upwards in response to the direction of view being directed towards a lower end of the scrollable cell or scrolled downwards in response to the direction of view being directed towards an upper end of the scrollable cell.

19. A system for providing a virtual reality graphical user interface, the system comprising a controller that is configured to:
receive an input indicating a current direction of view of a user; and,
generate and output a virtual reality simulation of the user's view of a simulated virtual reality environment for display on a virtual reality display, the virtual reality environment comprising the graphical user interface;
wherein the graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user; and
wherein, in response to receiving an indication of a selection of a selected cell of the one or more selectable cells, one or more further cells are positioned within the simulated virtual reality environment adjacent to the selected cell such that the graphical user interface is built around the user within the virtual reality environment.

20. A computer readable medium comprising computer executable instructions that, when executed by a computer, cause the computer to:
receive an input indicating a current direction of view of a user; and,
generate and output a virtual reality simulation of the user's view of a simulated virtual reality environment for display on a virtual reality display, the virtual reality environment comprising the graphical user interface,
wherein the graphical user interface comprises one or more selectable cells positioned within the simulated virtual reality environment at one or more corresponding fixed positions within the virtual reality environment relative to a position of the user within the virtual reality environment, the one or more fixed positions being independent of the direction of view of the user; and
wherein, in response to receiving an indication of a selection of a selected cell of the one or more selectable cells, one or more further cells are positioned within the simulated virtual reality environment adjacent to the selected cell such that the graphical user interface is built around the user within the virtual reality environment.
